(19) United States
(12) Patent Application Publication
(10) Pub. No.: US 2024/0349402 A1
(43) Pub. Date: Oct. 17, 2024

(54) Infrared radiators with an emissive layer applied to a reflector layer made of metal, and use of the emissive layer

(71) Applicant: Heraeus Noblelight GmbH, Hanau (DE)

(72) Inventors: Jürgen WEBER, Kleinostheim (DE); Frank DIEHL, Kleinostheim (DE)

(21) Appl. No.: 18/575,013

(22) PCT Filed: Apr. 14, 2023
(86) PCT No.: PCT/EP2023/059777

§ 371 Date: Dec. 28, 2023

(30) Foreign Application Priority Data
May 12, 2022 (DE) 102022111985.8

(51) Int. Cl. H05B 3/84

(52) U.S. Cl. CPC H05B 3/84

(57) ABSTRACT

Known infrared radiators have a radiator molded body with a reflector layer made of metal and applied thereto. Starting therefrom, in order to specify an infrared radiator which can be operated easily and cost-effectively and moreover over the longest possible period with a large electrical power density, it is proposed that an emissive layer with an emissivity that is greater over a wavelength range of 0.78 μm to 5 μm by at least a factor of 10 than the emissivity of the reflector layer at the same wavelength and temperature is applied to the reflector layer.

### TECHNICAL BACKGROUND

The invention relates to an infrared radiator having a radiator molded body with a reflector layer made of metal applied thereto.

Furthermore, the invention relates to the use of an emissive layer having an emissivity which is in the range of 0.81 to 0.99 in the wavelength range of 0.78 μm to 5 μm.

Infrared radiators within the meaning of the invention are designed to emit radiation in the infrared spectral range. They have a radiator molded body and can be divided according to their main emission wavelength into short-wave, medium-wave and long-wave infrared radiators. The main emission wavelengths of short-wave infrared radiators are in the range of 0.78 μm to 1.4 μm (=IR-A, rated temperature 1,800° C.-3,450° C., according to IEC 62798:2014, Section 4, Classification of infrared radiators by spectral emission, Table 1), those of medium-wave infrared radiators are in the range of above 1.4 μm to 3 μm (=IR-B, 690° C.-1,800° C.), and those of long-wave infrared radiators are in the range of above 3 μm to 1 mm (=IR-C, <690° C.).

Typical radiator molded bodies of known infrared radiators have a cylindrical shape, for example a pipe, plate or tile shape. Tubular infrared radiators can be elongated or curved, for example into a U shape or ring shape. Plate-shaped or tile-shaped radiator molded bodies have two opposing sides which can be flat or curved.

Known infrared radiators additionally comprise a radiation emitter, for example a heating tape arranged within a radiator pipe, or a heating coil, or a resistance element which is applied to a plate-shaped radiator molded body or incorporated therein, for example. The radiator molded body is frequently manufactured from quartz glass or ceramic. The radiator molded body serves to protect the radiation emitter, for example from mechanical or chemical stresses, and can contribute to the emission of infrared radiation and to the distribution of radiation. A radiator molded body in the form of a radiator pipe can be open or closed. In the latter case, it is frequently filled with an inert gas in order to protect the radiation emitter from oxidation.

A reflector layer made of metal, for example of gold, silver or aluminum, is applied to the radiator molded body and partially covers the surface of the radiator molded body. Moreover, the radiator molded body has a radiating surface for emitting infrared radiation. The radiating surface and the reflector layer do not overlap one another; they are arranged regularly on opposite sides of the radiator molded body.

### PRIOR ART

Infrared radiators are used to heat a heating material in a wide variety of industrial manufacturing processes. Operation of the infrared radiators with an electrical power density that is as large as possible is frequently desirable.

Since, in most cases, an infrared radiator should not emit radiation uniformly in all spatial directions, a reflector is frequently associated with known infrared radiators. This causes the radiation emission to be reduced in certain spatial directions and to be increased in other spatial directions. This can take place with an external, separate reflector. However, an infrared radiator with a reflector layer applied to the radiator molded body has a particularly compact design. A short-wave infrared radiator with a gold reflector applied to the radiator pipe is known from DE 10 2013 104 577 B3, for example.

A specular reflector layer made of metal, in particular of gold, exhibits excellent properties with regard to the reflection of infrared radiation; it is moreover also characterized by good mechanical and chemical stability. However, the limited thermal stability of the metal layer proves disadvantageous. This applies in particular when the infrared radiator is to be operated with a large electrical power density, and the reflector layer is moreover applied to the radiator molded body which is already loaded with high temperatures. In order to avoid damage to a reflector layer made of gold, it is therefore regularly necessary to cool the reflector layer at operating temperatures above 800° C., as described in DE 40 22 100 C1. However, such cooling is accompanied by a large space requirement. Moreover, air or water cooling has the disadvantage that turbulence can arise which can impair the heating of the heating material.

In the prior art, instead of reflector layers made of metal, layers made of other materials are therefore used, for example a reflector layer made of opaque quartz glass, as proposed in DE 10 2006 062 166 A1. However, in contrast to a directionally reflective layer made of metal, a layer made of opaque quartz glass acts as a diffuse reflector. With diffuse reflectors, radiation losses can occur due to multiple reflections, which can impair the radiation efficiency of the infrared radiator. A specularly reflective layer made of metal is moreover characterized by a smaller layer thickness.

### Technical Object

In known infrared radiators with a reflector layer made of metal and applied to the radiator molded body, the reflector layer exhibits limited thermal stability. The reflector layer temperature, from which the infrared radiator has to be extensively cooled, depends on the metal from which the reflector layer is manufactured. Cooling is required from a reflector layer temperature of more than 800° C. in the case of a reflector layer made of gold, from a reflector layer temperature of more than 700° C. in the case of a reflector layer made of silver, and from a reflector layer temperature of 400° C. in the case of a reflector layer made of aluminum. Operation of known infrared radiators with a high electrical power density, for example with an electrical power density of more than 2×40=80 W/cm for a twin pipe having a diameter of 23 mm×11 mm or with an electrical power density of 40 W/cm for a round pipe having a diameter of 10 mm, is therefore possible only with extensive cooling, depending on the pipe format.

With regard to many industrial applications, it is however desirable to be able to operate infrared radiators with as high an electrical power density as possible at the lowest possible cost. The invention is therefore based on the object of specifying an infrared radiator which can be operated easily and cost-effectively and moreover over the longest possible period with a large electrical power density.

Furthermore, the invention is based on the object of specifying a novel use for an emissive layer whose emissivity is in the range of 0.81 to 0.99 in the wavelength range of 0.78 μm to 5 μm.

### BRIEF DESCRIPTION OF THE INVENTION

With regard to the infrared radiator, this object is achieved according to the invention starting from an infrared radiator of the type mentioned at the outset in that an emissive layer with an emissivity that is greater over a wavelength range of 0.78 μm to 5 μm by at least a factor of 10 than the emissivity of the reflector layer at the same wavelength and temperature is applied to the reflector layer.

With known infrared radiators with a specularly reflective reflector layer made of metal, the electrical power density with which the infrared radiators can be operated maximally over a reasonable period of time (with or without additional cooling) is limited. The reason for this is the limited thermal stability of the reflector layer made of metal, which layer can exhibit decomposition phenomena by evaporating metal particles from a temperature depending on the respective metal. The present invention is based on the idea of counteracting the evaporation of metal particles by increasing the energy radiation of the reflector layer, namely by covering the reflector layer with an emissive layer. This is based on the following consideration:

If radiation impinges on a body, it is either allowed to pass through, reflected or absorbed. The following applies:

$$\\ \begin{matrix}Absorptance α = \frac{Absorbed radiation}{Incident radiation} & ( Eq . 1 )\end{matrix}$$

$$\\ \begin{matrix}Reflectance ρ = \frac{Reflected radiation}{Incident radiation} & ( Eq . 2 )\end{matrix}$$

$$\\ \begin{matrix}Transmittance τ = \frac{Passed ‐ through radiation}{Incident radiation} and & ( Eq . 3 )\end{matrix}$$

$$\\ \begin{matrix}α + ρ + τ = 1 & ( Eq . 4 )\end{matrix}$$

In the infrared wavelength range of 0.78 μm to 5 μm, reflector layers made of metal regularly have a high reflectance and a low absorptance and transmittance. For example, in the aforementioned wavelength range, a reflector layer made of gold regularly exhibits a reflectance of more than 0.95 and an absorptance and transmittance of less than 0.05 overall. At the temperature equilibrium, the absorptance a corresponds to the emissivity ε. The reflector layer thus has a comparatively low emissivity ε. However, the emissivity ε has a significant influence on the temperature of the radiator molded body and the infrared radiator overall. This is because the greater the emissivity ε of a body, the more energy it can release again per unit of time to its surroundings, which has an effect on its (operating) temperature. If the reflector layer is coated, as proposed according to the invention, with an emissive layer whose emissivity ε is greater than that of the reflector layer, the radiation of the infrared radiator overall increases, as a result of which the surface of the infrared radiator is passively cooled. The reflector layer and the emissive layer together form a layer composite with good radiation, which layer composite in its entirety has a higher overall emissivity than the reflector layer alone. The reflector layer is the lower, inner layer of the layer composite facing the radiator molded body. The emissive layer forms the upper, outer layer. The emissive layer has an emission-increasing effect in relation to the reflector layer. As a result, either
the infrared radiator is fed with a greater electrical power until the same temperature is reached, or
the temperature of the infrared radiator is lowered such that an otherwise necessary cooling can be reduced. This in particular has the advantage of reduced convection in the case of air or water cooling, which can have a disadvantageous effect on an irradiation process.

The reflector layer is located between the radiator molded body and the emissive layer. Since the emissive layer is closed and covers the reflector layer, it prevents or reduces the evaporation of particles from the reflector layer and thus contributes to an extension of the radiator service life.

With regard to passive cooling, good results are achieved if the emissivity ε of the emissive layer is greater over a wavelength range of 0.78 μm to 5 μm by at least a factor of 10, preferably by at least a factor of 25, particularly preferably by at least a factor of 40, than the emissivity ε of the reflector layer at the same wavelength and temperature.

The wavelength range of 0.78 μm to 5 μm includes the main emission wavelengths of short-wave, medium-wave and long-wave infrared radiators. Factor deviations in the wavelength ranges below 0.78 μm and above 5 μm are therefore at most of minor importance when using an emissive layer on a reflector layer of an infrared radiator. Preferably, the reflector layer is coated with a black emissive layer because a black emissive layer regularly exhibits a good emissivity ε over a wide wavelength range.

In principle, the following applies: The greater the emissivity ε of the emissive layer, the greater the radiation of a reflector layer coated therewith, and the better the passive cooling effect of the emissive layer.

It has proven particularly advantageous if the emissivity ε of the emissive layer is in the range of 0.81 to 0.99 in the wavelength range of 0.78 μm to 5 μm. Such an emissive layer has a high emissivity ε. Based on a conventional reflector layer made of gold with an emissivity ε of 0.02, this corresponds to a factor of more than 40. Based on a conventional reflector layer made of aluminum with an emissivity ε of 0.05, this corresponds to a factor of 16. Based on a conventional reflector layer made of silver with an emissivity ε of 0.03, this corresponds to a factor of 27. Such an emissive layer is outstandingly suitable for the passive cooling of a reflector layer applied to a radiator molded body. However, the emissivity ε of the emissive layer is advantageously at least 0.85.

The emissive layer advantageously contains an inorganic color pigment.

The emissive layer is preferably manufactured from a coating material which contains a color pigment or a precursor substance thereof. The coating material is, for example, a paste or a lacquer. The color pigment is thermally stable and is fixed, for example, by burning it onto the deposition surface. The color pigment can also be formed by thermal decomposition or chemical reaction of a precursor substance during or before baking.

The color pigment emits infrared radiation either in a wide wavelength range, for example from 2,000 nm to 8,000 nm, in particular from 2,000 nm to 4,700 nm, with an emissivity ε of 0.81 or higher, or in a narrow wavelength range, for example around 2,750 nm, with an emissivity ε of 0.81 or higher, preferably of at least 0.9.

In this context, it has proven advantageous if the color pigment contains black mineral particles and is alkali-free.

Preferably, the emissive layer is a black lacquer layer on a ceramic base. Color pigments which appear black in the visible wavelength range generally also absorb (and emit) light in the relevant infrared wavelength range. It has proven effective if the color pigment contains black mineral particles, such as, for example, copper chromite black spinel or manganese ferrite black pigment, and if it is alkali-free. The absence of alkalinity in the coating material has the advantage that a surface made of glass, in particular of quartz glass, does not devitrify, i.e., does not crystallize and lose its optical quality as a result, when heated in contact with the coating material.

It has proven successful if the emissive layer comprises opaque quartz glass.

Such an at least partially opaque quartz glass is described in DE 10 2004 051 846 A1 and has become known by the name “QRC” (quartz reflective coating). It has previously been used primarily as a material for producing diffusely reflective reflector layers. The QRC reflector layer is produced by means of a slip method in which a highly-filled, pourable, aqueous SiO₂ slurry is produced which contains amorphous SiO₂ particles. This is applied as a slurry layer onto a substrate, and then the slurry layer is dried and vitrified by forming a more or less opaque quartz glass layer.

In the case of an emissive layer which comprises an opaque quartz glass in addition to the color pigment-containing coating material, the color pigment-containing coating material and the opaque quartz glass supplement one another in their emissivity, and the opaque quartz glass can act as an adhesion promoter to the coating material, in particular in the case of a base body made of quartz glass. Preferably, the opaque quartz glass forms a lower layer and the color pigment-containing coating material forms an upper layer of the emissive layer.

The lower layer made of opaque quartz glass can, on the one hand, itself act as a reflector and, on the other hand, contributes to improving the adhesion of the upper layer made of the coating material. Moreover, the lower layer also absorbs a portion of the infrared radiation and also emits it again.

On the one hand, the additional upper layer made of the coating material causes an increase in the emissivity ε in the relevant wavelength range. Moreover, it also causes a higher absorption of the short-wave or medium-wave primary radiation and thereby enables faster heating of the infrared radiator (and thus earlier operational readiness).

The lower layer made of opaque quartz glass shows, on the one hand, a certain transmission for the short-wave or medium-wave primary radiation and, on the other, can also act as a diffuse reflector for the primary radiation.

It has proven successful if the emissive layer has a layer thickness in the range of 1 μm to 200 μm, preferably in the range of 30 μm to 100 μm.

With a layer thickness of less than 1 μm, the passive cooling effect of the emissive layer is lost. A layer thickness of more than 200 μm can be produced only by repeated application in layers. At the same time, as the thickness of the emissive layer increases, the risk that the emissive layer peels off when it is exposed to temperature differences during operation increases. This applies accordingly to the upper layer made of the coating material, whose thickness is preferably less than 0.1 mm, and is preferably in the range of 1 μm to 50 μm. Advantageously, the emissive layer is heat resistant at least to 1,000° C., preferably at least to 1,200° C. It has been found that good heat resistance of the emissive layer is accompanied by a longer service life of the reflector layer and thus of the infrared radiator.

Depending on the pipe format, the infrared radiator is advantageously designed to generate, in the uncooled state under standard conditions, an electrical power density of up to 80 W/cm: for example, to generate an electrical power density of up to 80 W/cm in the case of a twin pipe having a diameter of 23 mm×11 mm and of up to 40 W/cm in the case of a round pipe having a diameter of 10 mm.

In a preferred embodiment of the invention, the radiator molded body is a radiator pipe made of quartz glass.

The radiator pipe preferably surrounds a radiation emitter, provided with a power connection, in the form of a heating coil or a heating tape. The radiator pipe has, for example, a round, oval or polygonal cross-section or is designed as a so-called twin pipe radiator, which has a cross-section in the shape of a horizontal eight. The outer wall of the radiator pipe is, for example, smooth, or is roughened. Short-wave infrared radiators in particular have a piston-shaped radiator pipe closed on both sides, wherein the power supply is led out at one end or at both ends.

The radiator pipe material is, for example, quartz glass and has a comparatively low inherent emissivity for infrared radiation, in particular in the wavelength range of around 2,200 to 3,100 nm. The radiator pipe has a radiating surface, which is generally located on the radiator pipe lateral surface. The reflector layer is opposite the radiating surface. By completely coating the reflector layer with an emissive layer, the reflector layer is modified with regard to a higher emissivity.

For example, the radiating surface, the reflector layer and the emissive layer each cover a partial area of the radiator pipe lateral surface, wherein the radiating surface does not overlap with the area of the reflector layer or with the area of the emissive layer. It is advantageous if the radiating surface, the area of the reflector layer and the area of the emissive layer overlapping the reflector area supplement one another such that they cover the entire lateral surface.

In a preferred embodiment of the invention, the emissive layer covers at least 80% of the reflector layer. Preferably, however, the emissive layer completely covers the reflector layer. In this context, it has proven successful if the emissive layer is dimensioned such that it projects beyond the reflector layer on all sides. This ensures that the reflector layer is completely protected by the emissive layer, even in the event of an unintentional, for example production-related, minimal displacement of the emissive layer relative to the reflector layer. This increases the thermal stability of the reflector layer.

When using a radiator pipe, it has proven advantageous if both the radiating surface and the reflector layer area and the area of the emissive layer each have a straight side extending parallel to the radiator pipe longitudinal axis and a curved side extending in a radiator pipe cross-sectional plane, wherein the straight side respectively extends over the entire length of the radiator pipe or a portion thereof. The curved side can be described by the position of the radiator pipe longitudinal axis as the center point through the central angle in the cross-sectional plane and the outer radius of the radiator pipe. Preferably, the reflector area extends over a central angle in the range of 0 degrees to 270 degrees, particularly preferably over a central angle in the range of 0 degrees to 180 degrees. It has proven advantageous if the curved side of the emissive layer is 5% larger than the curved side of the reflector layer, wherein the emissive layer is arranged in relation to the reflector layer such that it overlaps the reflector layer on both sides.

However, the area covered by the emissive layer preferably extends over a central angle between 0 degrees and 275 degrees, particularly preferably between 0 degrees and 195 degrees.

In a particularly preferred second modification of an embodiment of the infrared radiator with a radiator molded body in the shape of a radiator pipe made of quartz glass, at least a portion of the radiator pipe lateral surface has a surface roughness, defined as an arithmetic mean roughness Rₐ, where Rₐ is in the range of 0.5 μm to 5 μm, preferably in the range of 0.8 μm to 3.2 μm, a first circumferential section of which is covered by the reflector layer.

The roughness with an Rₐ value of 0.8 μm corresponds to the roughness class 6 and typically occurs during rough grinding, and the Rₐ value of 3.2 μm corresponds to the roughness class 8, which defines roughed-down surfaces. The lateral surface of the cladding tube is preferably roughened only where the reflector layer or the emissive layer is to be applied. Roughening improves the adhesion of the reflector layer and of the emissive layer, in particular in the case of an emissive layer in the form of a color pigment-containing coating material, such as a lacquer or a paste. Roughening of the surface is carried out, for example, mechanically or chemically, and in particular by grinding, sandblasting, or etching. In the case of a high surface roughness Rₐ of more than 5 μm, the optical quality of the radiating surface suffers, without significant gain in the adhesion-promoting effect. In the case of a low surface roughness Rₐ of less than 0.5 μm, no significant contribution to an adhesion-promoting effect results.

In another particularly preferred modification of the infrared radiator, the radiator molded body in the form of a tile is formed from a material emitting infrared radiation when heated, wherein the tile has opposing planar sides, of which the one first planar side is covered by the reflector layer and the emissive layer, and the other second planar side defines the radiating surface. The second planar side is preferably applied with an electrical contacting for the supply of a heating current to a heating conductor track connected thereto and made of a resistance material.

Tile-shaped infrared radiators are surface radiators with, generally, predominantly two-dimensional radiation characteristics. The tile material is preferably a ceramic, in particular Al₂O₃ or ZrO₂, or it comprises a composite material, in particular a matrix made of quartz glass, in which elemental silicon or carbon is embedded.

The possible size of the tile surface depends upon the properties of the material and the required dimensional stability.

Some tile materials change their color when there is an increase in temperature. This means that their emissivity, and thus the peak emission wavelength of the primary radiation, becomes shorter. In particular the pigment-containing coating material and the opaque quartz glass do not lose any or lose only little of their emissivity, even at high temperatures of up to, for example, 1,100° C.

Finally, the use of an emissive layer of the type mentioned at the outset is proposed for the passive cooling of a reflector layer made of metal and applied to a radiator molded body of an infrared radiator.

### Definitions

### Emissivity ε

Due to its temperature, each body emits heat rays. The emissivity ε indicates how much radiation a body releases in comparison to a black body. According to Kirchhoff's law of radiation, the radiation power originating from an arbitrary body is equal to that of the black body of the same temperature multiplied by the emissivity of the arbitrary body. The following applies:

$$\\ P = ε \cdot {P}_{s} ; where 0 \leq ε \leq 1$$

where: P radiation power of the arbitrary body,
   Pₛ radiation power of the black body of the same temperature, and
   ε emissivity of the arbitrary body.
The emissivity ε is determined as follows:

The emissivity at room temperature is measured with an integrating sphere. The latter permits the measurement of the directional hemispherical spectral reflectance R_{gh} and of the directional hemispherical spectral transmittance T_{gh}, from which the normal spectral emissivity is calculated. The measurement of the reflectance and transmittance in the wavelength range of 0.78 μm to 2.5 μm can, for example, take place using a Perkin Elmer Lambda 950 grating spectrometer. In the wavelength range of 1.4 μm to 18 μm, a Bruker IFS 66v Fourier-transform infrared (FTIR) spectrometer can be used, for example.

The measurement of the emissivity at higher temperatures takes place in the wavelength range of 0.7 to 5 μm by means of an FTIR spectrometer, for example using a Bruker IFS 66v Fourier-transform infrared spectrometer (FTIR), to which a black-body boundary conditions (BBC) sample chamber is coupled via an additional optical unit. In the half-chambers in front of and behind the sample holder, the sample chamber has temperature-controllable black-body environments and a beam output opening with detector. The sample is heated to a predetermined temperature in a separate oven and, for measuring, is brought into the beam path of the sample chamber with the black-body environments set to the predetermined temperature. The intensity detected by the detector is composed of an emission component, a reflection component and a transmission component, namely of the intensity emitted by the sample itself, the intensity falling from the front half-chamber onto the sample and reflected by the latter, and the intensity falling from the rear half-chamber onto the sample and transmitted by the latter. In order to determine the individual variables of emissivity, reflectance and transmittance, three measurements must be carried out.

### Electrical Power Density

The electrical power density is measured in the unit “electrical power per heated length” (W/cm); it is almost 100% converted into optical power (W/m²).

### Standard Conditions

A temperature of 298.15 K (25° C., 77° F.) and an absolute pressure of 100 kPa (14.504 psi, 0.986 atm) apply as standard conditions (SATP conditions).

### Total Irradiance ε

The term “total irradiance” (also: optical power) denotes the ratio of the perpendicularly impinging radiation power to the impingement surface. It is measured in the unit W/m².

### Mean Roughness Rₐ

The arithmetic mean roughness Rₐ is determined in accordance with EN ISO 25178. This is a line roughness parameter. To determine the measured value Rₐ, the surface area of a defined measured distance is scanned (with a fine needle), and all differences in elevation and depth of the surface area are recorded. After calculating the specific integral of this roughness profile on the measured distance, the result is divided by the length of the measured distance.

### DETAILED DESCRIPTION OF THE INVENTION

The invention is explained in more detail below with reference to an exemplary embodiment and a drawing. The following are shown in detail:

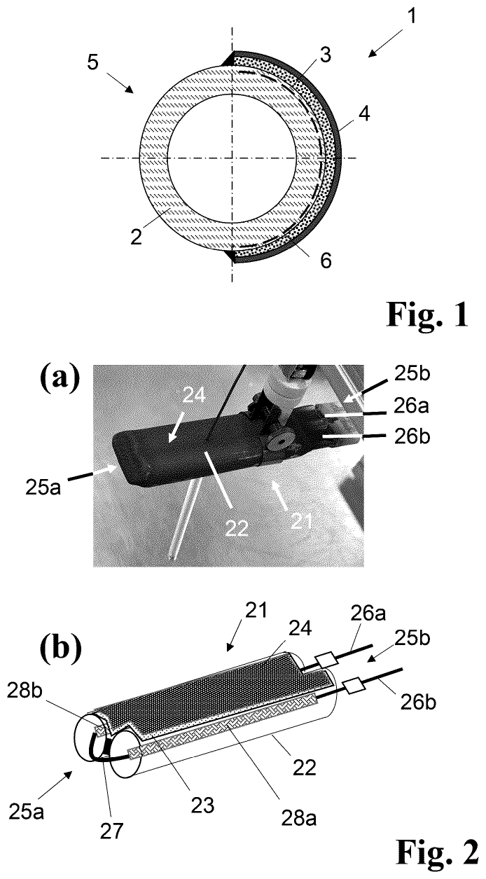

FIG. 1 an embodiment of an infrared radiator with a reflector layer made of gold and an emissive layer applied thereto, in cross section and in a schematic representation,

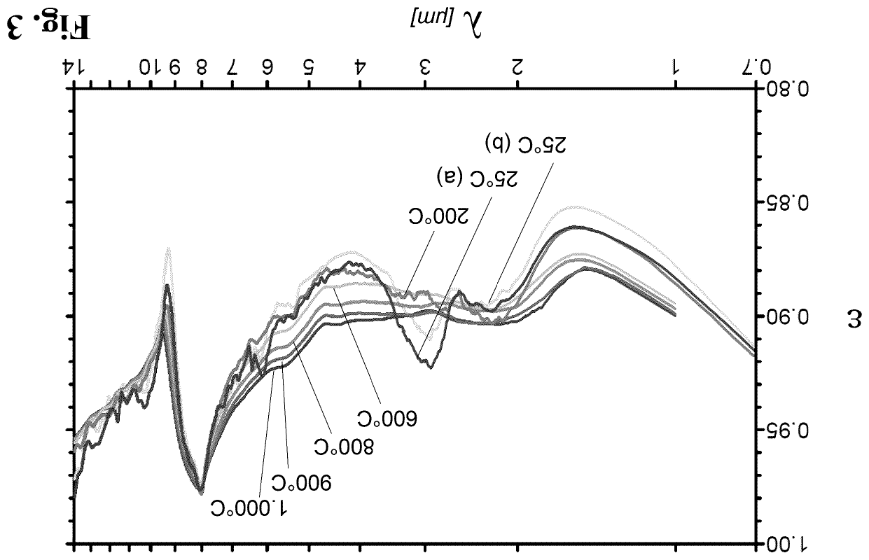

FIG. 2a a photo of an embodiment of an infrared radiator with a twin pipe to which a reflector layer made of gold and an emissive layer are applied,

FIG. 2b the infrared radiator of FIG. 2a in a schematic perspective representation,

FIG. 3 a diagram in which the emissivity ε of an emissive layer at different temperatures (25° C., 200° C., 600° C., 800° C., 900° C. and 1,000° C.) is shown as a function of the wavelength λ,

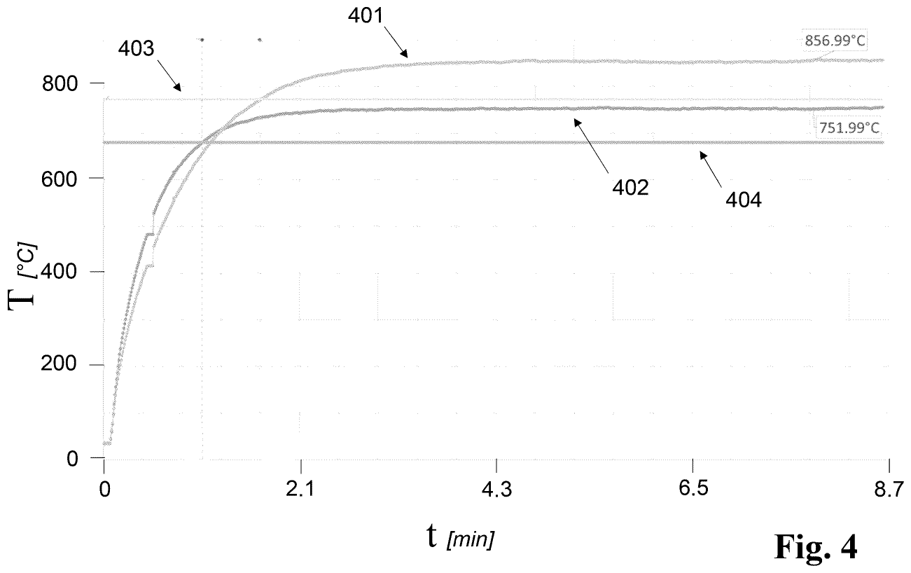

FIG. 4 a temperature-time diagram in which the temperature profile on the reflector side of an infrared radiator according to the invention and coated with a black lacquer and the temperature profile on the reflector side of a traditional infrared radiator are plotted,

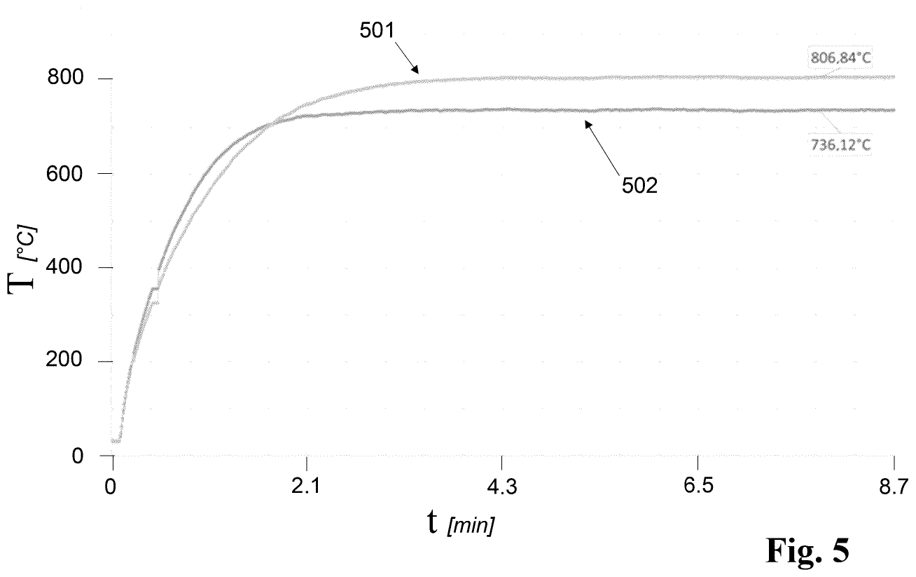

FIG. 5 a temperature-time diagram in which the temperature profile on the radiation exit side of an infrared radiator according to the invention and coated with a black lacquer and the temperature profile on the radiation exit side of a traditional infrared radiator are plotted,

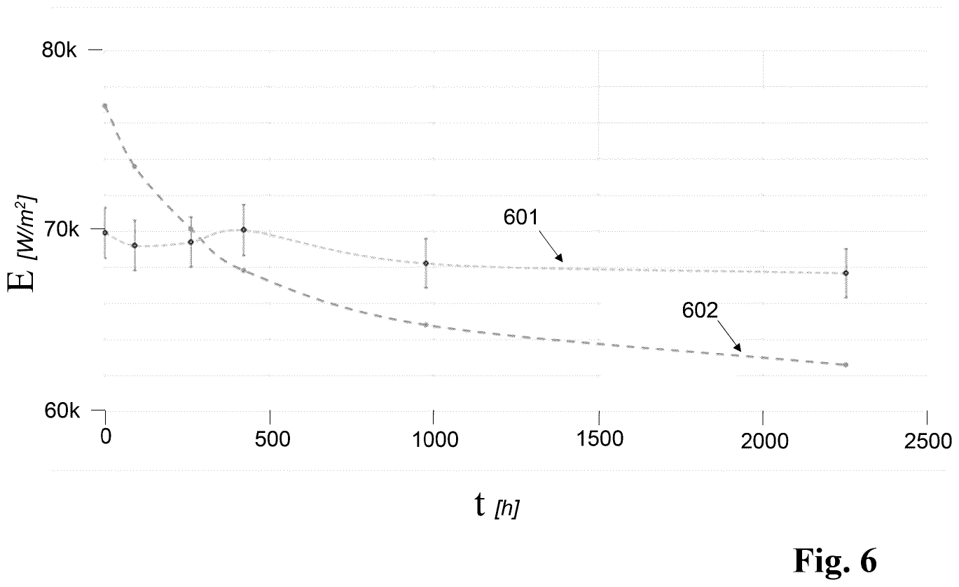

FIG. 6 an irradiance-time diagram in which the irradiance profile of an infrared radiator according to the invention and coated with a black lacquer and the irradiance profile of a traditional infrared radiator are plotted, and

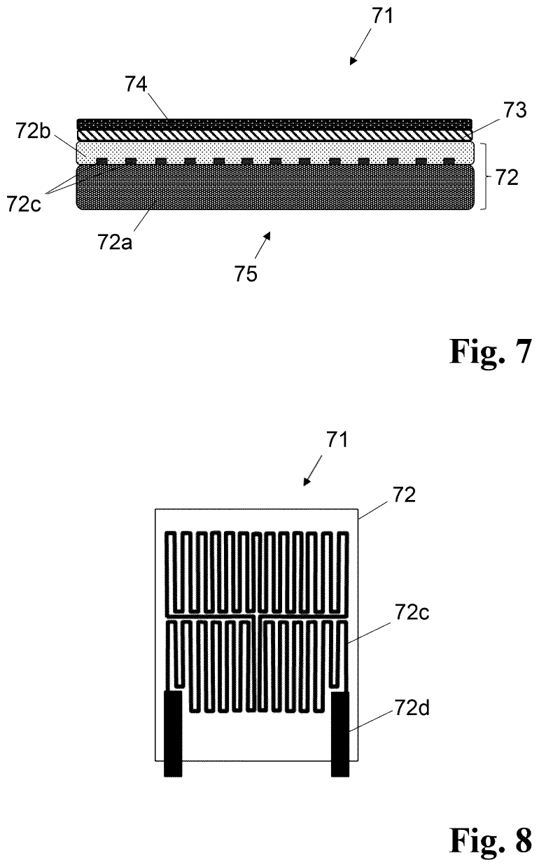

FIGS. 7, 8 a second embodiment of an infrared radiator with a planar, plate-shaped radiator molded body.

FIG. 1 schematically shows an infrared radiator according to the invention in cross section, which radiator is assigned reference sign 1 overall. The representation is not to scale; in particular, the thicknesses of the components and layers may be shown thicker to improve recognizability.

The infrared radiator 1 has a radiator pipe 2 made of quartz glass. The radiator pipe 2 is cylindrical and has a length of 80 mm, a width of 23 mm and a height of 11 mm. The radiator pipe 2 is closed at both ends; it surrounds a tungsten heating wire (not shown) which is provided with an electrical connection and can be heated to temperatures of up to 2,300° C. The lateral surface of the radiator pipe 2 is semi-tubularly (180°) coated with a reflector layer 3 made of gold. In an alternative configuration, the reflector layer 3 consists of aluminum or of silver. The reflector layer 3 has a layer thickness of 0.2 μm and an emissivity of 0.02; it reduces the emissivity in the gold-coated region and causes very good reflection of impinging radiation so that the radiation emitted by the heating wire is radiated substantially in the direction of the lateral surface not provided with the reflector layer 3.

The reflector layer 3 is moreover coated with an emissive layer 4 made of a black high-temperature lacquer on a ceramic base, so that the reflector no longer visually appears golden but black.

On a smooth radiator pipe lateral surface with a reflector layer 3 made of gold, but also made of silver or aluminum, the emissive layer 4 may, under certain circumstances, peel off at a high temperature over a few hundred hours. In order to improve the adhesion of the lacquer layer 3 to the reflector layer 3, the radiator pipe surface is roughened before the reflector layer is applied. The region of the roughening 6 is symbolized by a dashed line.

Roughening is carried out mechanically by sandblasting or grinding, or chemically by treatment with an etching solution. A suitable etching solution (NH₄+HF+ acetic acid) and its application for roughening a quartz glass surface are described in DE 197 13 014 C2. The mean roughness depth Rₐ is preferably in the range of 5 μm to 50 μm; in the exemplary embodiment, it is 25 μm.

The emissive layer 4 retains its black color, and thus also its emission spectrum, when heated to 800° C. and beyond; it is temperature resistant up to 1,200° C. The emissivity of the emissive layer 4 is 0.9. The thickness of the emissive layer 4 is approximately 40 μm. The non-coated lateral surface of the radiator pipe 2 forms the actual radiating surface 5 of the infrared radiator 1.

At a reflector layer temperature above 600° C., evaporation of gold from the reflector layer 3 may already occur. In the infrared radiator 1, the emissive layer 4 applied to the reflector layer 3 heats up during operation with an electrical power density of 2×40 W/cm up to 780° C. “Absorption=emission” applies so that the emissive layer 4 releases the absorbed radiation just as quickly again with high intensity. As a result, during operation of the infrared radiator 1, the emissive layer 4 cools the reflector layer 3 passively by means of radiation; it thus counteracts an evaporation of gold particles from the reflector layer 3 and serves as an evaporation barrier and protective lacquer. Not only does the emissive layer 4 increase the service life of the infrared radiator 1, but the radiation power also remains stable during operation of the infrared radiator 1 with higher electrical power densities, as a result of which the infrared radiator 1 can advantageously be used in particular in temperature-sensitive processes.

Production of the Reflector Layer 3 from Gold

The reflector layer 3 is produced by applying a gold-containing emulsion (gold resinate) to the surface of the radiator pipe 2 using a brush. The emulsion is subsequently baked by heating. During baking, the gold resinate resolves into metallic gold and resin acid which, like the other components of the paste, are volatilized by the high baking temperature. What remains is a closed, specular gold layer 4 that acts as a reflector and whose thickness is preferably in the range of 50 nm to 300 nm, depending on the reflectance requirement. The thicker the layer, the higher its reflectance.

### Production of the Emissive Layer 4

The emissive layer 4 is produced by spraying or brushing on a thermal paint. The thermal paint is alkali-free. It contains an alumino-silicate solution (10 to 20 wt %), copper chromite black spinel as mineral color pigment (25 to 35 wt %), and water (40 to 60 wt %). Suitable thermal paints are offered commercially as oven paints by, for example, the companies ULFALUX Lackfabrikation GmbH (e.g., Ulfalux®-Thermobeschichtung 1590ST) and Aremco Products, Inc., wherein the following are indicated as further organic ingredients: xylene, ethyl acetate, butyl acetate, ethylbenzene.

Repeated painting ensures a completely closed layer. After spraying, the thermal paint is dried at 250° C. and is then touch-resistant. The final state is achieved by heating the lacquer layer 3 to 1,200° C. Such heating can take place when putting the infrared radiator into operation. Ceramic components are sintered onto the lamp tube's surface, and a solid substance-to-substance bond is produced so that the emissive layer 4 is largely scratch resistant.

The photo of FIG. 2a shows a further embodiment of an infrared radiator according to the invention, which is assigned reference sign 21 overall. The infrared radiator 21 has a radiator pipe 22 in the form of a twin pipe made of two quartz pipes arranged next to one another. The quartz pipes each have a width of 23 mm, a height of 11 mm with a length of 200 mm; they are fused together in the direction of their longitudinal axes and together form a component. The twin pipe structure enables high radiation density and good mechanical stability. The two quartz pipes of the twin pipe each surround a tungsten heating wire (not shown). The radiator pipe 22 is closed at its two pipe ends 25a, 25b. The heating tapes are connected in series (not shown) in such a way that the electrical connections 26a, 26b for the electrical contacting of the heating tapes are led out of the radiator pipe 22 via a crimping at one of the radiator pipe ends 25b. The opposite radiator pipe end 25a is fused.

A gold layer (not visible) is applied to the radiator pipe 22 and is coated with an emissive layer 24. The emissivity of the gold layer is 0.02 in the wavelength range of 780 nm to 5 μm. The emissivity of the emissive layer 24 is 0.85.

FIG. 2b schematically shows the structure of the infrared radiator 21 of FIG. 2a in a simplified perspective representation. Insofar as the same reference signs are used in the embodiment of FIG. 2b as in FIG. 2a, they denote structurally identical or equivalent components and parts as are explained in more detail above with reference to the description of FIG. 2a.

For reasons of better illustration, the fusing of the radiator pipe end 25a and the crimping of the radiator pipe end 25b are omitted in FIG. 2b and, instead, the gold layer 23, which cannot be seen in FIG. 2a, as well as the carbon heating tapes 28a, 28b and the electrical contacting thereof are shown.

The carbon heating tapes 28a, 28b are connected in series. Their electrical contacting takes place via the electrical connections 26a, 26b, which are each electrically conductively connected to one of the carbon heating tapes 28a, 28b. In order to enable crimping of the radiator pipe 23 in the region of the electrical connections 26a, 26b, the electrical connections 26a, 26b are each provided with a metal plate of low thickness, preferably made of molybdenum. The carbon heating tapes 28a, 28b are electrically conductively connected to one another via the connecting element 27.

The gold layer 23 has a layer thickness of 0.1 μm to 0.2 μm. It covers approximately 50% of the lateral surface of the radiator pipe 22. The emissive layer 24 is applied to the gold layer. The emissive layer 24 covers the gold layer completely; it covers approximately 55% of the lateral surface of the radiator pipe 22. The emissive layer is a paint layer of black thermal dispersion paint with the following composition:

| | |
|---|---|
| Aluminosilicate solution | 15 wt % |
| Copper chromite black spinel | 30 wt % |
| Water | 40 wt % |
| Volatile organic components | 15 wt %. |

After the application and drying, the paint layer is burnt in and sintered at a temperature of approximately 1,200° C. to form a black emissive lacquer layer with a layer thickness of 40 μm (production and properties of the lacquer layer and the thermal paint are explained with reference to FIG. 1). FIG. 3 shows a diagram in which the emissivity ε of this emissive layer is shown at different temperatures (25° C., 200° C., 600° C., 800° C., 900° C. and 1,000° C.) as a function of the wavelength λ. Two curves are indicated for the temperature 25° C., wherein curve (a) reflects the emission profile before the heating of the lacquer layer, and (b) reflects the emission profile after the heating of the lacquer layer to 1000° C. and subsequent cooling. Over a wavelength range with wavelengths λ of 0.7 μm to 5 μm, and even up to 14 μm, the emissive layer consistently shows an emissivity ε in the range of 0.85 to 0.98 at the aforementioned temperatures. A temperature change in the aforementioned range is thus accompanied by minor changes in the emissivity. Due to their good temperature stability with simultaneously minor changes in emissivity and simultaneously good adhesive properties to a metal layer, in particular made of gold, silver or aluminum, the previously described black emissive layer is suitable for use on a radiator pipe of an infrared radiator.

The temperature-time diagram of FIG. 4 shows the temperature profiles detected on the reflector side in a traditional infrared radiator with a gold reflector on the one hand and in an infrared radiator according to the invention with a coated gold reflector on the other hand.

Two infrared radiators with basically the same structure were used to detect the temperature profiles. The infrared radiator 21 described in FIGS. 2A and 2B was used as the infrared radiator according to the invention; a structurally identical infrared radiator with a reflector layer 23 made of gold, but without an emissive layer 24, served as the traditional infrared radiator.

The temperature was detected in a contactless manner using a pyrometer, starting with the switching on of the relevant infrared radiator at the time t=0 min. at room temperature. After less than 5 min., both infrared radiators have reached a constant operating temperature. The curve profile 401 was recorded with the traditional infrared radiator without an emissive layer. At the temperature equilibrium, the operating temperature Tₛₛ≈857° C.

The curve profile 402 was recorded with the infrared radiator 21 according to the invention. At the temperature equilibrium, the operating temperature Tₛₛ≈752° C. The operating temperature of the infrared radiator 21 according to the invention thus remains below the 90% value of the operating temperature of the traditional infrared radiator T_{90, SdT}=771° C., which is shown as an auxiliary line 403 in the diagram. The emissive layer 24 provided according to the invention exhibits good radiation emission; it acts as passive cooling for the reflector. For comparison purposes, the auxiliary line 404 shows the 90% value of the operating temperature (T_{90, Inv}=677° C.) of the infrared radiator 21 according to the invention. The intersection point of the curve profile 402 with the auxiliary line 404 is also reached more quickly than the intersection point of the curve profile 401 with the auxiliary line 403. This shows that the infrared radiator 21 according to the invention also reaches its temperature equilibrium more quickly than the traditional infrared radiator.

FIG. 5 shows, in a further temperature-time diagram, the temperature profiles on the radiation exit side opposite the reflector side, both in the case of a traditional infrared radiator with a gold reflector and in the case of an infrared radiator according to the invention with a coated gold reflector. The measurement with the same measuring arrangement as already described with respect to FIG. 4.

The curve profile 501 reflects the temperature on the radiation exit side of the traditional infrared radiator; the curve profile 502 reflects the temperature on the radiation exit side of the infrared radiator 21 according to the invention. Compared to the temperature profile on the reflector side (see FIG. 4), lower operating temperatures are achieved on the radiation exit side at the temperature equilibrium. This is because the radiation exit side exhibits a high transmission and less radiation is absorbed as a result. The maximum values here are T_{SS, SdT}≈807° C. and T_{SS, Inv}≈736° C. As for the rest, the same effect of the emissive layer 24 on the reflector layer 23, namely a reduction of the infrared radiator temperature by passive cooling, is also exhibited on the radiation exit side.

Since the luminosity of an infrared radiator with a reflector layer made of gold is not the same on all sides and only the luminosity in the region of the radiation exit seems relevant, the integrated total irradiance in the half-chamber of 90° to 270°, i.e., on the radiation exit side, is plotted in relation to the operating time in the diagram shown in FIG. 6. For this purpose, an infrared radiator 21, as described in detail above with reference to FIGS. 2A and 2B, and a structurally identical infrared radiator without an emissive layer 24 were operated for 2,250 hours with a rated voltage U_{Nenn} of 100 V, and the integrated total irradiance was determined in each case. The curve profile 601 was obtained for the infrared radiator 21 with an emissive layer 24; the curve profile 602 was obtained with the traditional infrared radiator. It is found here that the integrated total irradiance in the traditional infrared radiator decreases more quickly and more strongly than in an infrared radiator whose gold reflector layer is covered with an emissive layer. The emissive layer is therefore accompanied by an extended service life of the infrared radiator. Endurance tests have shown that the lacquer layer or the infrared radiator can achieve an operating time of up to 10,000 hours without visual or functional impairments.

FIG. 7 shows a side view and FIG. 8 shows a sectional representation of a second embodiment of an infrared radiator according to the invention, which is assigned reference sign 71 overall. The infrared radiator 71 has a plate-shaped radiator molded body 72, which comprises a matrix 72a made of quartz glass, a conductor track 72c applied to the matrix 72a, and a cover layer 72b.

The plate-shaped radiator molded body 72 has a rectangular shape with a plate thickness of 2.5 mm. It consists of a matrix 72a made of quartz glass. The matrix 72a has a visually translucent to transparent effect. When viewed microscopically, it exhibits no open pores and, at most, closed pores with maximum dimensions of less than 10 μm on average.

The conductor track 72c is manufactured from tantalum. The conductor track 72c has a cross-sectional area of at least 0.02 mm² with a width of 1 mm and a thickness of 20 μm. At both ends of the conductor track, contacts 72d made of tantalum are welded to the conductor track 72c. The contacts 72d have a cross-sectional area of at least 0.5 mm². Since the contacts have a larger cross-sectional area than the conductor track, they exhibit a lower electrical resistance than the conductor track 72c; with current flowing through, they are therefore heated less strongly than the conductor track 72c. The contacts therefore cause a reduction of the temperature so that an electrical contacting of the conductor track 72c via the contacts 72d is simplified.

The conductor track 72c is fixedly connected to that of the matrix 72a in that a cover layer 72b made of glass is applied to the surface of the matrix 72a provided with the conductor track 72c. The cover layer 72b is manufactured from a glass whose coefficient of thermal expansion is in a range between the coefficient of thermal expansion of the matrix 72a and the coefficient of thermal expansion of the conductor track 72c. The cover layer 72b has a mean layer thickness of 1.8 mm. The cover layer 72b covers the entire heating region of the radiator molded body 72. It covers the conductor track 72c completely and thus shields the conductor track 72c from chemical or mechanical influences from the environment.

A reflector layer 73 made of gold with a layer thickness of 60 μm is applied to the cover layer 72b. The reflector layer 73 is coated with an emissive layer 74 having a layer thickness of 100 μm; it consists of the same thermal paint as mentioned in the description of the embodiment of FIG. 1.

The radiating surface of the infrared radiator 71 is denoted by reference sign 75.

1. An infrared radiator having a radiator molded body with a reflector layer made of metal and applied thereto, characterize an emissive layer whose emissivity is greater over a wavelength range of 0.78 μm to 5 μm by at least a factor of 10 than the emissivity of the reflector layer at the same wavelength and temperature is applied to the reflector layer.

2. The infrared radiator according to claim 1, wherein the emissive layer has an emissivity that is in the range of 0.81 to 0.99 in the wavelength range of 0.78 to 5 μm.

3. The infrared radiator according to claim 1, wherein the emissive layer contains an inorganic color pigment.

4. The infrared radiator according to claim 3, wherein the color pigment contains black mineral particles and is alkali-free.

5. The infrared radiator according to claim 1, wherein the emissive layer has a layer thickness in the range of 1 μm to 200 μm.

6. The infrared radiator according to claim 1, wherein the emissive layer is heat-resistant at least to 1,000° C., preferably at least to 1,200° C.

7. The infrared radiator according to claim 1, wherein the emissive layer covers at least 80% of the reflector layer.

8. The infrared radiator according to claim 1, wherein it is designed to generate, in the uncooled state under standard conditions, an electrical power density of up to 120 W/cm.

9. The infrared radiator according to claim 1, wherein the radiator molded body is a radiator pipe made of quartz glass.

10. The infrared radiator according to claim 1, wherein a reflector layer made of gold, silver or aluminum is applied to the radiator molded body.

11. A use of an emissive layer with an emissivity that is in the range of 0.81 to 0.99 in the wavelength range of 0.78 μm to 5 μm, for the passive cooling of a reflector layer made of metal and applied to a radiator molded body of an infrared radiator.
